(19) United States
(12) Patent Application Publication
(10) Pub. No.: US 2009/0213797 A1
(43) Pub. Date: Aug. 27, 2009

(54) METHOD FOR BINDING UPDATE IN MOBILE IPV6 AND MOBILE IPV6 COMMUNICATION SYSTEM

(75) Inventor: Chunqiang Li, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/395,178

(22) Filed: Feb. 27, 2009

Related U.S. Application Data
(63) Continuation of application No. PCT/CN2007/070361, filed on Jul. 26, 2007.

(30) Foreign Application Priority Data
Aug. 31, 2006 (CN) 200610111876.9

(51) Int. Cl. H04W 40/00

(52) U.S. Cl. 370/328

(57) ABSTRACT

A method for binding update in the mobile IPv6 is provided. After a binding management key is obtained in a return routability procedure, a home address (HoA) in a binding update (BU) packet is sent in a form of an encrypted option. In the BU process, an HoA index may also be bound. A corresponding mobile IPv6 communication system and a mobile node (MN), a correspondent node (CN), and a home agent (HA) in the communication system are also provided. Thus, the HoA appears only once in an encrypted form in a packet sent to the CN in the BU process, thereby improving the security of the HoA in the BU process.

The present application is a continuation of International Patent Application No. PCT/CN2007/070361, filed Jul. 26, 2007, which claims the benefit of Chinese Patent Application No. 200610111876.9, filed Aug. 31, 2006, both of which are hereby incorporated by reference in their entireties.

### BACKGROUND OF THE INVENTION

1. Field of the Invention

The present invention relates to the technical field of network communication, and more particularly to a method for binding update in the mobile Internet Protocol version 6 (IPv6) and a mobile IPv6 communication system.

2. Description of the Related Art

The mobile Internet Protocol version 6 (IPv6) is a mobility solution on the network layer. The mobile IPv6 has three basic network entities, namely, mobile node (MN), correspondent node (CN), and home agent (HA).

An MN can be uniquely identified by a home address (HoA). When the MN roams to a foreign network, a care-of address (CoA) will be generated in a certain manner. According to the mobile IPv6, in the process that an MN moves from one link to another, the ongoing communication of the MN using the HoA may not be interrupted. The mobility of the node is transparent to the transfer layer and other upper-layer protocols. The mobile IPv6 defines two different modes to solve the mobility problem, i.e., a bi-directional tunnel mode and a route optimization mode.

In the bi-directional tunnel mode, the MN informs the HA of the CoA through a binding update (BU) message. The HA intercepts packets sent to the home network of the MN for communication with the MN, and forwards the packets to the MN in the tunnel mode. When the MN sends packets to a CN, the packets must be sent to the HA in the tunnel mode, and the HA decapsulates and forwards the tunnel packets to the CN.

In the route optimization mode, the MN needs to register with the CN. Firstly, a return routability procedure (RRP) is performed. The RRP includes the exchange of two messages pairs between the MN and CN: the Home Test Init (HoTI) message and Home Test (HoT) message, and the Care-of Test Init (CoTI) message and Care-of Test (CoT) message. The HoTI and HoT are forwarded by the HA, and the CoTI and CoT are directly exchanged between the MN and the CN. After the RRP is successfully performed, the MN is able to binding update the CoA and HoA into a binding cache list of the CN through a BU message, and directly transmits packets to the CN in the subsequent communication. Thus, the packets need not to be forwarded by the HA.

The privacy of location is vital in the mobile IPv6 communication. Without concealment, sensitive data of a subscriber may be collected and analyzed, and activities of the subscriber may be detected and traced, thus resulting in a serious threat to the security of the mobile subscriber. When the MN is on a foreign link, the inner header of the packet transmitted between the MN and the HA through a tunnel carries the HoA of the MN. When the MN communicates with the CN in the route optimization mode, the HoA option contained in the packet sent from the MN to the CN includes the HoA of the MN, and the Type-2 routing header contained in the packet sent from the CN to the MN also includes the HoA of the MN.

In order not to expose the HoA of the MN on a foreign link to an eavesdropper, currently, a substitute of HoA (SHoA) is used to replace the real HoA. However, to implement this method, in addition to the HoA and CoA of the MN, the SHoA and the HoA also need to be bindingly updated in the BU process.

An implementing method is described as follows. 16 bits out of the 128-bit IPv6 address space are allocated as a prefix of temporary mobile identifiers (TMIs), and all addresses using the prefix are regarded as the TMIs which are specified to be unroutable. A 128-bit TMI is allocated to each MN, and the TMI changes periodically based on a certain algorithm. In the BU process to the CN, the TMI is placed in the HoA option, and the real HoA is placed in a redefined BU sub-option. The CN binds the TMI, HoA, and CoA. In the subsequent communication, the MN and CN adopt the TMI to replace the current HoA in the HoA option and the Type-2 routing header.

In the implementation of the present invention, the inventor finds out that the above method at least has the following defects: 1. the HoA in the RRP is not protected, and the BU packet still has to directly carry the HoA; 2. the IPv6 address space is permanently occupied; 3. if the periodical change of the TMI and the change of the CoA are not synchronous, extra RRPs need to be performed, and more network resources will be consumed; and 4. if multiple HoAs of an MN are bound to the same CoA, confusion may occur.

In addition, when the MN performs the binding update, the sequence numbers contained in the BU packets may also expose the activities of the mobile subscriber. If the increment of the sequence numbers of the BU packets is fixed, or the rules of the change of the sequence numbers can be easily identified, the eavesdropper may still guess the movement of the MN by detecting a series of BU messages.

### SUMMARY OF THE INVENTION

Accordingly, the present invention is directed to a method for binding update in the mobile IPv6 and a corresponding mobile IPv6 communication system, so as to enhance the security of home addresses (HoAs) in a binding update (BU) process.

To achieve the objective of the present invention, technical solutions are provided as described below. A method for binding update in the mobile IPv6 includes the following steps: A mobile node (MN) uses a substitute of home address (SHoA) to send a BU message to a correspondent node (CN), and the BU message carries an HoA encrypted with a binding management key (Kbm); the Kbm is generated based on keygen tokens received from the CN in a return routability procedure (RRP); the CN binds the SHoA, the HoA, and a care-of address (CoA) according to the BU message.

A mobile IPv6 communication system including an MN, a CN, and a home agent (HA) is provided. The MN is adapted to send a Care-of Test Init (CoTI) message to the CN, send a Home Test Init (HoTI) message to the HA, receive a Care-of Test (CoT) massage containing a care-of keygen token returned by the CN, receive a Home Test (HoT) message containing a home keygen token forwarded by the HA, generate a Kbm based on the home keygen token and the care-of keygen token, add an encrypted HoA option carrying an HoA encrypted with the Kbm in a BU message, and use an SHoA to replace the HoA for sending the BU message. The HA is adapted to forward the HoTI message to the CN, with carrying the SHoA in a destination option extension header containing an SHoA option of the HoTI message, receive the HoT message sent by the CN, search for the corresponding HoA of the MN according to the SHoA in a Type-2 routing header of the HoT message, and forward the HoT message to the MN in a tunnel mode. The CN is adapted to receive the HoTI message forwarded by the HA, replace the HoA with the SHoA to generate the home keygen token, return the HoT message containing the home keygen token to the HA, and carrying the SHoA in the Type-2 routing header of the HoT message, and bind the SHoA, the HoA, and a CoA according to the BU message.

In an embodiment of the present invention, an MN in an IPv6 communication system is provided. The MN includes a first return routability unit, a Kbm unit, and a first BU unit. The first return routability unit is adapted to perform a return routability procedure (RRP) including obtaining keygen tokens from a CN. The Kbm unit is adapted to generate a Kbm based on the keygen tokens. The first BU unit is adapted to send a BU message to the CN by using a SHoA to replace a HoA of the MN, and carry the HoA encrypted with the Kbm in the BU message.

In an embodiment of the present invention, a CN in an IPv6 communication system is provided. The CN includes a second return routability unit, a Kbm unit, and a second BU unit. The second return routability unit is adapted to perform an RRP including returning keygen tokens to an MN in the RRP. The Kbm unit is adapted to generate a Kbm based on the keygen tokens. The second BU unit is adapted to obtain an HoA of the MN encrypted with the Kbm from a BU message sent by the MN, and bind an SHoA of the MN, the HoA of the MN, and a CoA of the MN.

In the method of the present invention, the SHoA replaces the HoA to perform the RRP, and the HoA in the BU packet is sent in a form of an encrypted option after the Kbm is obtained. As such, the HoA appears only once in an encrypted form in the packet sent to the CN in the BU process, thus improving the security of the HoA in the BU process.

### BRIEF DESCRIPTION OF THE DRAWINGS

The present invention will become more fully understood from the detailed description given herein below for illustration only, and thus are not limitative of the present invention, and wherein:

FIG. 1 is a schematic flow chart of a method for binding update in the mobile IPv6 according to a first embodiment of the present invention;

FIG. 2 is a schematic flow chart of a method for binding update in the mobile IPv6 according to a second embodiment of the present invention;

FIG. 3 is a schematic flow chart of a method for binding update in the mobile IPv6 according to a third embodiment of the present invention;

FIG. 4 is a schematic structural view of a mobile IPv6 transmission system according to a fourth embodiment of the present invention; and

FIG. 5 is a schematic view showing internal structures of an MN, a CN, and an HA in the mobile IPv6 transmission system according to the fourth embodiment of the present invention.

### DETAILED DESCRIPTION OF THE EMBODIMENTS

In a method for binding update in the mobile IPv6 provided in the present invention, a substitute of home address (SHoA) replaces a home address (HoA) to perform a return routability procedure (RRP), and after a binding management key (Kbm) is obtained, the HoA in a binding update (BU) packet is sent in a form of an encrypted option. In the BU process, an HoA index may be bound as well. The present invention also provides a preferred method for calculating an SHoA and a sequence number of a BU packet. Moreover, the present invention further provides a related mobile IPv6 transmission system. The methods and system of the present invention are illustrated in detail below.

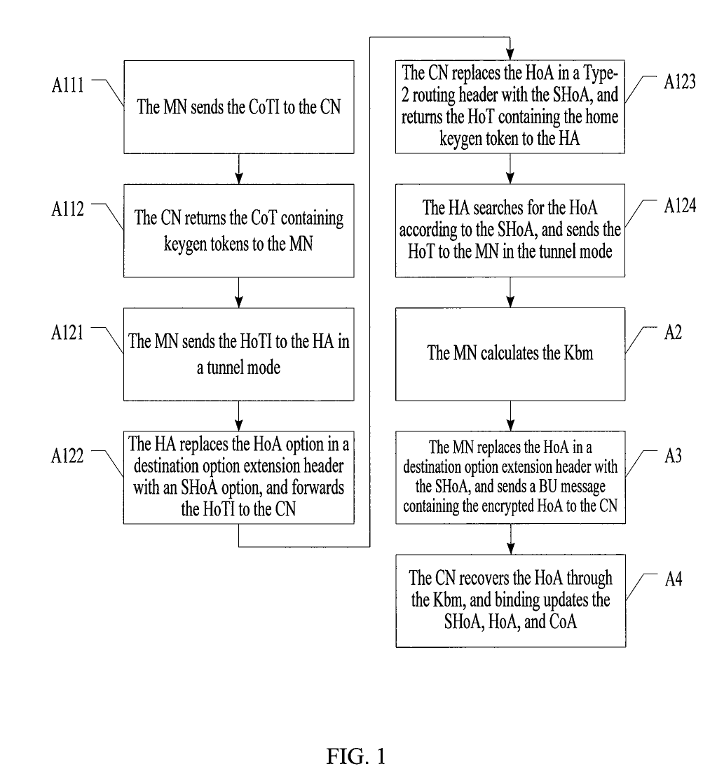

Embodiment 1: a method for binding update in the mobile IPv6. FIG. 1 shows the process of the method including the following steps.

A1. A mobile node (MN) perform an RRP with a home agent (HA) and a correspondent node (CN) by using a SHoA to replace a HoA of the MN.

The RRP is a procedure mainly for ensuring the security of the communication between a MN and a CN. The principle of the RRP is to authenticate the registration between the MN and the CN by encrypting the signaling exchanged there-between. The CN may figure out whether it can access the MN in the optimized routing and triangular routing modes through the RRP. If the RRP test fails, the CN cannot receive the BU from the MN, nor directly send packets to a care-of address (CoA) of the MN. The test generally includes the transmission of two message pairs: the Home Test Init (HoTI) message and Home Test (HoT) message, and the Care-of Test Init (CoTI) message and Care-of Test (CoT) message. The CoTI and CoT messages are directly exchanged between the MN and the CN, and the HoTI and HoT messages are forwarded by the HA between the MN and the CN. For the MN, the HoTI and CoTI messages may be transmitted at the same time, and for the CN, the HoT and CoT messages may also be transmitted at the same time.

As the packets in the interaction of the CoTI and CoT messages do not involve the HoA of the MN, this part of interaction can be implemented by the existing procedures in the present invention. The interaction between the HoTI and HoT messages includes a part between the MN and HA and a part between the HA and CN. The packets are sent in a tunnel mode between the MN and HA, so the inner packet is protected by an encapsulating security payload (ESP) header of the tunnel mode, and the security level is high. Therefore, the present invention mainly deals with the part of the interaction between the HA and CN in the RRP.

In this embodiment, the RRP is implemented as follows:

A11. The CoTI message interacts with the CoT message. This step further includes the following two sub-steps.

A111. The MN sends the CoTI message to the CN. In an IPv6 header of the packet, a source address is the CoA, a destination address is the CN, and a mobility header is the CoTI message.

A112. After receiving the CoTI message, the CN calculates and generates a care-of keygen token according to the CoA, and then sends the CoT message containing the care-of keygen token to the MN. In an IPv6 header of the packet, a source address is the CN, a destination address is the CoA, and a mobility header is the CoT message.

A12. The HoTI message interacts with the HoT message. This step further includes the following four sub-steps.

A121. The MN sends the HoTI message to the HA in the tunnel mode. In an outer IPv6 header of the packet, a source address is the CoA, and a destination address is the HA. In an inner IPv6 header protected by the ESP header in the tunnel mode, a source address is the HoA, a destination address is the CN, and a mobility header is the HoTI message.

A122. After receiving the HoTI message sent by the MN in the tunnel mode, the HA performs an IP protocol security (IPSec) processing to obtain the inner IPv6 packet. The source address in the inner packet is replaced by the HA, and a destination option extension header is added between the IPv6 packet and the mobility header to forward the HoTI message to the CN. Generally, an HoA option is placed in the destination option extension header to carry the HoA. In this embodiment, the HA replaces the HoA with a corresponding SHoA so as to hide the HoA of the MN. Thus, a new option, that is, an SHoA option is used to carry the SHoA in the destination extension header.

To guarantee the privacy of the SHoA, and to ensure that the SHoA can be obtained by the HA and MN through calculation, the method for calculating the SHoA in this embodiment is as follows:

SHoA=First (128,PRF(Kmh,Message1))

where Kmh is a shared key between the MN and HA, and Message1 is composed of information that may be shared by the MN and HA, such as the CoA, HoA, CN address, and HA address. In this embodiment, Message1=(CoA|HoA|CN), that is, Message1 is formed by connecting the CoA, HoA, and CN. The SHoA may change with the CoA by adding the CoA into the expression for generating the SHoA, different HoAs bound to the same CoA may generate different SHoAs by adding the HoA into the expression, and different CN communications may use different SHoAs by adding the CN into the expression. PRF is a pseudo-random function, indicating that the Kmh is employed to process the message Message1 to generate a pseudo-random output. Here, PRF may be a Hash message authentication code algorithm function, for example, HMAC_SHA1. First is a cut-off function for cutting off the first few bits of the output hash of the PRF. As the SHoA is used to replace the HoA, the length of the SHoA must be consistent with that of the HoA, and thus 128 bits are cut off in the above expression. After the HA calculates the SHoA, the association between the SHoA and the HoA is stored.

A123. After receiving the HoTI message, the CN knows that the SHoA is used according to the option type in the destination option extension header. Therefore, when a home keygen token is calculated, the SHoA is used. Then, the HoT message containing the home keygen token is sent. Generally, a Type-2 routing header needs to be configured in a sent packet to carry the HoA of the MN. In the present invention, the CN uses the corresponding SHoA to replace the HoA. In an IPv6 header of the sent packet, a source address is the CN, a destination address is the HA, the Type-2 routing header carries the SHoA, and a mobility header is the HoT message.

A124. After receiving the HoT message sent by the CN, the HA needs to forward the HoT message to the MN in the tunnel mode. Firstly, the corresponding HoA is found according to the SHoA in the Type-2 routing header, and then the destination address in the IPv6 header of the HoT message is replaced by the HoA. After that, the tunnel encapsulation and packet sending are performed. In the outer IPv6 header of the sent packet, a source address is the HA, a destination address of the CoA, a source address in the inner IPv6 header protected by the ESP header in the tunnel mode is the CN, a destination address is the HoA, and a mobility header is the HoT message.

Here, Steps A11 and A12 may be performed concurrently.

A2. After the MN receives the CoT message directly sent by the CN and the HoT message forwarded by the HA, the RRP ends, and the MN generates a Kbm according to the home keygen token and care-of keygen token returned by the CN. Generally, the Kbm is calculated according to the following expression:

Kbm=HMAC_{—}SHA1 (Home Keygen Token|Care-of Keygen Token)

That is, the Kbm is obtained by performing a Hash algorithm HMAC_SHA1 on the sequence composed of the home keygen token and care-of keygen token.

A3. The MN sends the BU message to the CN to perform the binding update. Normally, the packet in the BU message carries the destination option extension header including the HoA option for carrying the HoA. In the present invention, to hide the HoA, the MN places the corresponding SHoA in the HoA option to replace the HoA. Meanwhile, to send the association between the HoA and SHoA to the CN, the MN uses the encrypted HoA option in the BU message, and places the HoA encrypted with the Kbm in the encrypted HoA option. In an IPv6 header of the BU packet, a source address is the CoA, and the destination address is the CN. The destination option extension header carries the HoA option for placing the SHoA, and a mobility header is the BU message including the options of the sequence number, encrypted HoA option, home temporary random number index, care-of temporary random number index, and message authorization code. Among the above, the encrypted HoA option is newly added in the present invention.

A4. After receiving the BU message from the MN, the CN recovers the HoA from the encrypted HoA option through the Kbm, and then binding updates the SHoA, HoA, and CoA to the binding cache list. Normally, the CN returns a binding acknowledge (BA) message to the MN, indicating that the BU process is completed. Then, the MN and CN can perform packet transmission directly in the route optimization mode.

To prevent the HoA of the MN from being exposed to an eavesdropper in the subsequent packet transmission, the HoA option of the destination option extension header carries the SHoA in the packet sent to the CN from the MN, and the Type-2 routing header carries the SHoA in the packet sent to the MN from the CN. Thus, the eavesdropper cannot obtain the HoA of a mobile subscriber through packet interception.

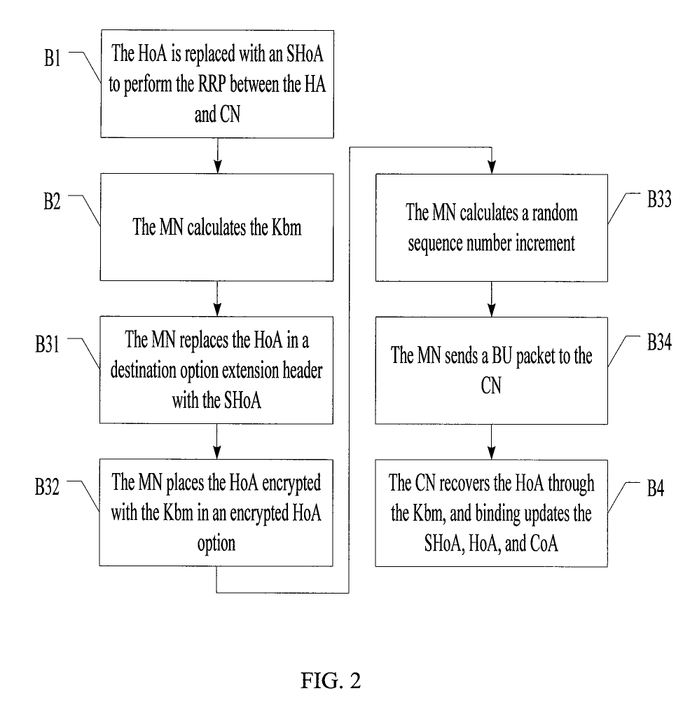

Embodiment 2: a method for binding update in the mobile IPv6. FIG. 2 shows the process of the method, which includes steps similar to those of Embodiment 1. The difference between Embodiment 2 and Embodiment 1 lies in that this embodiment adopts a method for generating a random sequence number of a BU packet in the following steps.

B1. An SHoA replaces an HoA to perform an RRP between an HA and a CN. For details, refer to Step A1 of Embodiment 1.

B2. After an MN receives a CoT message directly sent by the CN and an HoT message forwarded by the HA, the RRP ends. The MN generates a Kbm according to a home keygen token and a care-of keygen token returned by the CN.

B3. The MN sends a BU message to the CN to perform the binding update. This step further includes the following four sub-steps.

B31. The MN places the corresponding SHoA in an HoA option of a destination option extension header of a packet for sending the BU message to replace the HoA.

B32. The BU message uses an encrypted HoA option, and places the HoA encrypted with a Kbm in the encrypted HoA option.

B33. A random sequence number increment (seq_increment) is calculated. The obtained seq_increment is added to a previous sequence number to obtain a sequence number of the BU message, and the sequence number is placed in an option of the BU message. In this embodiment, the expression for calculating the seq_increment is as follows:

seq_increment=First (8,PRF(Kbm,Message2))

where Message2 is a message containing a previous sequence number (Seq#) or a previous seq_increment, and is expressed as follows:

Message2=(Seq#|Expression), or

Message2=(seq_increment#|Expression);

where the Expression is obtained by combining the information associated with and shared by the MN and CN, for example, the CoA and HoA of the MN and the address of the CN. Certainly, the Expression may be null. In this embodiment, the pseudo-random function PRF is HMAC_SHA1, and the First function cuts off the first eight bits.

In particular, to improve the intractability of the sequence numbers, if the seq_increment calculated according to the previous method is zero, a new seq_increment is calculated with the following expression:

seq_increment=First(8,Kbm XOR HoA)

where XOR is an Exclusive-OR function for performing an Exclusive-OR operation on the Kbm and HoA.

Here, Steps B31 to B33 may be performed concurrently.

B34: The BU packet is sent. In an IPv6 header of the BU packet, a source address is the CoA, and a destination address is the CN. A destination option extension header carries an HoA option for placing the SHoA, and a mobility header is the BU message including options such as the sequence number and the encrypted HoA option.

B4: After receiving the BU message from the MN, the CN recovers the HoA from the encrypted HoA option through the Kbm, and then bindingly updates the SHoA, HoA, and CoA to the binding cache list.

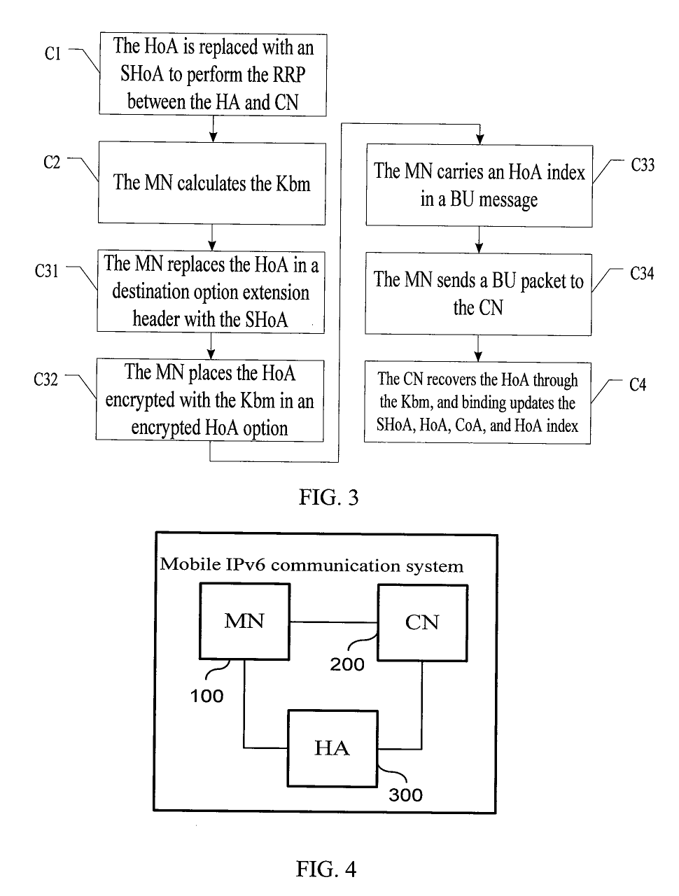

Embodiment 3: a method for binding update in the mobile IPv6. FIG. 3 shows the process of the method, which includes steps similar to those of Embodiment 1. The difference between Embodiment 3 and Embodiment 1 lies in that in this embodiment, when an MN sends a BU packet to perform the binding update, an HoA index corresponding to each HoA is also carried to bind the HoA, CoA, SHoA, and HoA index. Embodiment 3 includes the following steps.

C1: An SHoA replaces an HoA to perform an RRP between an HA and a CN. For details, refer to Step A1 of Embodiment 1.

C2. After an MN receives a CoT message directly sent by the CN and an HoT message forwarded by the HA, the RRP ends. The MN generates a Kbm according to a home keygen token and a care-of keygen token returned by the CN.

C3. The MN sends a BU message to the CN to perform the binding update. This step further includes the following four sub-steps.

C31: The MN places the corresponding SHoA in an HoA option of a packet for sending the BU message to replace the HoA.

C32: The BU message uses an encrypted HoA option, and places the HoA encrypted with a Kbm in the encrypted HoA option.

C33. The BU message carries an HoA index.

The HoA index is a value corresponding to each HoA of the MN provided by the MN. When an MN has one or more HoAs, an HoA list is stored in a cache of the MN. The list is stored as an array, a chained list, or in other formats. Each of the n (n>=1) HoAs of the MN is uniquely mapped to a number set of 0 to n−1 (or 1 to n). For example, 0 to n−1 (or 1 to n) are array subscripts of the HoA list stored as the array, or marks of the storage positions of the HoAs. Therefore, the array subscripts of the HoA list of the MN can be used as the HoA index, through which the corresponding HoAs can be obtained directly.

Here, Steps C31 to C33 may be performed concurrently.

C34. The BU packet is sent. In an IPv6 header of the BU packet, a source address is the CoA, and a destination address is the CN. A destination option extension header carries an HoA option for placing the SHoA, and a mobility header is the BU message including options such as the sequence number, the encrypted HoA option, and the HoA index.

C4. After receiving the BU message from the MN, the CN recovers the HoA from the encrypted HoA option through the Kbm, and then bindingly updates the SHoA, HoA, CoA, and HoA index to the binding cache list.

Certainly, as the HoA index needs to be stored, binding cache entries of the HA and of the CN must be further added with an HoA index field.

After the binding update of this embodiment is completed, in the subsequent packet sending, a new “binding index extension header” carrying the HoA index may be used to replace the HoA option or the Type-2 routing header. The HoA index is but a short pointer value, and the HoA option and Type-2 routing header both have 128 bits no matter carrying the HoA or SHoA. Therefore, the length of the header is greatly reduced. Further, as the parameter corresponding to the HoA appearing in the packet is only the HoA index, the security is improved. Certainly, the “binding index extension header” is not mandatory, and a “binding index option” may be added to the mobility header to carry the HoA index.

Embodiment 4: a mobile IPv6 communication system. As shown in FIG. 4, the system includes an MN 100, a CN 200, and an HA 300.

The MN 100 is adapted to send a CoTI message to the CN 200, send an HoTI message to the HA 300, receive a CoT massage containing a care-of keygen token returned by the CN 200, receive an HoT message containing a home keygen token forwarded by the HA 300, generate a Kbm based on the home keygen token and the care-of keygen token, add an encrypted HoA option in a BU message carrying an HoA encrypted with the Kbm, and use an SHoA to replace the HoA for sending the BU message to the CN 200.

The HA 300 is adapted to forward the HoTI message to the CN 200, carry a destination option extension header containing an SHoA option and carry the SHoA in a sent packet, receive the HoT message sent by the CN 200, search for the corresponding HoA according to the SHoA in a Type-2 routing header in the packet, and forward the HoT message to the MN 100 in a tunnel mode.

The CN 200 is adapted to receive the HoTI message forwarded by the HA 300, replace the HoA with the SHoA to generate the home keygen token, return the HoT message containing the home keygen token to the HA 300, carry the Type-2 routing header carrying the SHoA in the sent packet, and bind the SHoA, the HoA, and a CoA according to the BU message.

The system of this embodiment may be applied in the BU methods of Embodiments 1 to 3.

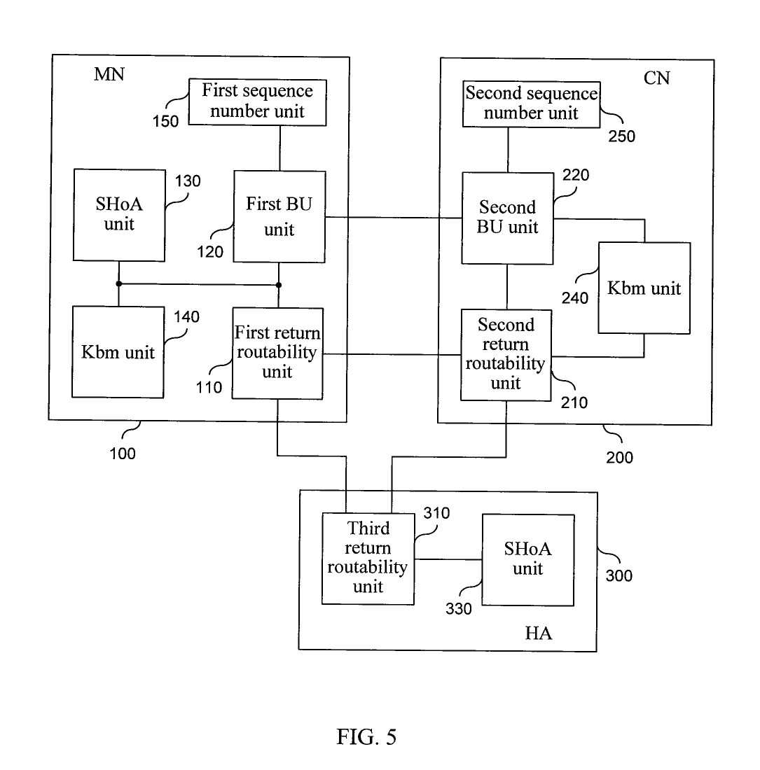

FIG. 5 shows the internal structures of the MN 100, the CN 200, and the HA 300 of the mobile IPv6 communication system in Embodiment 4.

The MN 100 includes a first return routability unit 110, a first BU unit 120, and a Kbm unit 140, and may further include an SHoA unit 130 and a first sequence number unit 150.

The SHoA unit 130 is adapted to calculate and generate the SHoA according to a shared key with the HA 300 and a message containing the CoA, the HoA, an address of the CN 200, and/or an address of the HA 300, and provide the SHoA to the first return routability unit 110 and the first BU unit 120 for use.

The first return routability unit 110 is adapted to perform a return routability procedure (RRP) including obtaining keygen tokens from a second return routability unit 220 of the CN 200, in which the keygen tokens include the care-of keygen token and the home keygen token obtained from the CoT message and the HoT message respectively, and outputting the keygen tokens to the Kbm unit 140.

The Kbm unit 140 is adapted to generate the Kbm based on the keygen tokens, and provide the Kbm to the first return routability unit 110 and the first BU unit 120 for use.

The first BU unit 120 is adapted to use the SHoA to replace the HoA for sending the BU message to a second BU unit 220 of the CN 200, and carry the HoA encrypted with the Kbm in the BU message. Thus, the CN 200 can update the binding of the SHoA, HoA, and CoA accordingly. The first BU unit 120 may carry an HoA index corresponding to each HoA in the BU message, so the CN 200 may bind the HoA index, SHoA, HoA, and CoA.

The BU message often carries a sequence number, which may be provided by the first BU unit 150. The first BU unit 150 adds a previous sequence number and a current sequence number increment to generate a current sequence number. Here, the current sequence number increment is calculated according to the Kbm and the previous sequence number or a previous sequence number increment. Details of the algorithm for calculating the sequence number increment are described in the above embodiments of the method, and will not be described herein again.

The CN 200 includes a second return routability unit 210, a second BU unit 220, and a Kbm unit 240, and may further include a second sequence number unit 250.

The second return routability unit 210 is adapted to perform an RRP including replacing the HoA with the SHoA to perform an RRP with a third return routability unit 310 of the HA 300, and returning the keygen tokens to the first return routability unit 110 of the MN 100. The keygen tokens include the home keygen token and the care-of keygen token. The care-of keygen token is generated by the second return routability unit 210 according to the CoA of the MN 100, and is sent to the MN 100 in the CoT message in the RRP. The home keygen token is generated by the second return routability unit 210 according to the SHoA, and is sent to the MN 100 in the HoT message in the RRP.

The second return routability unit 210 outputs the generated keygen tokens to the Kbm unit 240. The Kbm unit 240 calculates and generates the Kbm based on the keygen tokens, and provides the Kbm to the second BU unit 220.

The second BU unit 220 is adapted to receive the BU message sent by the first BU unit 120 of the MN 100, decrypt the HoA in the BU message according to the Kbm provided by the Kbm unit 240, and bind the SHoA, HoA, and CoA of the MN 100. If the BU message includes the HoA index, the second BU unit 220 may further include an address index module for binding the HoA index value, SHoA, HoA, and CoA.

If the MN 100 includes the first sequence number unit 150, the CN 200 will include a corresponding second sequence number unit 250. The second sequence number unit 250 uses the same method to calculate the current sequence number as the first sequence number 150, so as to receive the BU message from the MN 100 correctly.

The HA 300 includes a third return routability unit 310, a second BU unit 220, and an SHoA unit 130. The SHoA unit 130 is adapted to calculate and generate the SHoA according to a shared key with the MN 100 and a message containing the CoA, the HoA, an address of the CN 200, and/or an address of the HA 300, and provide the SHoA to the third return routability unit 310 for use. The third return routability unit 310 is adapted to perform an RRP including replacing the HoA with the SHoA to perform the RRP with the second return routability unit 210 of the CN 200.

According to the embodiments of the present invention, the HoA is replaced with the SHoA in the RRP. After the Kbm is obtained, the HoA in the BU packet is sent as an encrypted option, so that the HoA appears only once in an encrypted form in the packet sent to the CN in the BU process, thereby improving the security of the HoA in the BU process. Further, according to the embodiments of the present invention, the HoA may be added to the expression for generating the SHoA, and thus multiple HoAs bound to the same CoA are different from one another to prevent the confusion. Moreover, according to the embodiments of the present invention, the HoA index is bound with the HoA and CoA, so that a new extension header containing the HoA index may be used to replace the HoA option or Type-2 routing header carrying the HoA in the subsequent packet transmission, which greatly saves the header space, provides higher security to mobile subscribers, and does not cause confusion when multiple HoAs of the MN are bound to the same CoA. In addition, according to the embodiments of the present invention, a method for calculating the sequence numbers of the BU packets is also provided to make the sequence numbers have a random increment that can be known by both the MN and CN, and thus the sequence numbers become untraceable.

In view of the above, the method for binding update in the mobile IPv6 and the mobile IPv6 communication system have been described in detail. The principle and implementation of the present invention are illustrated with specified embodiments. However, the above embodiments are only intended to explain the method and key points of the present invention, instead of limiting the scope thereof. It will be apparent to those skilled in the art that various modifications and variations can be made to the structure of the present invention without departing from the spirit of the invention. Therefore, the present invention is not limited to the above content of the specification.

What is claimed is:

1. A mobile node (MN) in an IPv6 communication system, comprising:
a first return routability unit, adapted to perform a return routability procedure (RRP) comprising obtaining keygen tokens from a correspondent node (CN);
a binding management key (Kbm) unit, adapted to calculate and generate the Kbm based on the keygen tokens; and
a first binding update (BU) unit, adapted to send a BU message to the CN by using a substitute of home address (SHoA) to replace a home address (HoA) of the MN, and carry the HoA encrypted with the Kbm in the BU message.

2. The MN in an IPv6 communication system according to claim 1, further comprising an SHoA unit adapted to generate the SHoA according to a shared key with a home agent (HA) and a message containing a care-of address (CoA) of the MN, the HoA, an address of the CN, and/or an address of the HA.

3. The MN in an IPv6 communication system according to claim 1, wherein the BU message further comprises an HoA index, and each HoA of the MN is corresponding to each value of the HoA index.

4. The MN in an IPv6 communication system according to 1, wherein the BU message further comprises a sequence number; and
the MN further comprises a first sequence number unit adapted to obtain a current sequence number by adding a previous sequence number and a current sequence number increment, and the current sequence number increment is calculated according to the Kbm and the previous sequence number or a previous sequence number increment.

5. A method for binding update in the mobile IPv6, comprising:
sending, by a mobile node (MN), a binding update (BU) message to a correspondent node (CN) from a substitute of home address (SHoA), wherein the BU message carries a home address (HoA) encrypted with a binding management key (Kbm), and the Kbm is generated based on keygen tokens received from the CN in a return routability procedure (RRP); and
binding, by the CN, the SHoA, the HoA, and a care-of address (CoA) according to the BU message.

6. The method for binding update in the mobile IPv6 according to claim 5, wherein the keygen tokens received from the CN comprise a home keygen token; and
the return routability procedure (RRP) comprises:
forwarding, by a home agent (HA), a Home Test Init (HoTI) message from the MN to the CN, and carrying the SHoA in a destination option extension header of the HoTI message;
calculating, by the CN, the home keygen token according to the SHoA, returning a Home Test (HoT) message containing the home keygen token to the HA, and carrying the SHoA in a Type-2 routing header of the HoT message; and
searching, by the HA, for the corresponding HoA of the MN according to the SHoA in the Type-2 routing header, and forwarding the HoT message to the MN in a tunnel mode.

7. The method for binding update in the mobile IPv6 according to claim 6, wherein the keygen tokens received from the CN further comprise a care-of keygen token; and
the RRP further comprises: sending, by the MN, a Care-of Test Init (CoTI) message to the CN, and obtaining a Care-of Test (CoT) message containing the care-of keygen token returned by the CN.

8. The method for binding update in the mobile IPv6 according to claim 5, wherein when the BU message is sent, the BU message further comprises an HoA index, and each value of the HoA index is corresponding to each HoA of the MN;
the binding by the CN according to the BU message, further comprises that the CN binds the SHoA, the HoA, the HoA index, and the CoA according to the BU message.

9. The method for binding update in the mobile IPv6 according to claim 8, wherein each value of the HoA index is a position mark or an array subscript of each HoA in an HoA list stored in the MN.

10. The method for binding update in the mobile IPv6 according to claim 5, wherein the SHoA is calculated according to a shared key between the MN and the HA and a message containing the CoA, the HoA, an address of the CN, and/or an address of the HA.

11. The method for binding update in the mobile IPv6 according to claim 10, wherein the SHoA is obtained according to an expression as follows:
SHoA=First (M,PRF(Kmh,Message1))
wherein the SHoA is the substitute of home address of the MN, the Kmh is the shared key between the MN and the HA, the Message1 is the message containing the CoA and the HoA of the MN, the address of the CN, and/or the address of the HA, the PRF is a pseudo-random function, the First is a cut-off function, and the M is a natural number smaller than or equal to 128.

12. The method for binding update in the mobile IPv6 according to 5, wherein the BU message further comprises a sequence number, the sequence number is a sum of a previous sequence number and a sequence number increment, and the sequence number increment is calculated according to the Kbm and the previous sequence number or a previous sequence number increment.

13. The method for binding update in the mobile IPv6 according to claim 12, wherein the sequence number increment is obtained according to an expression as follows:
seq_increment=First(N,PRF(Kbm,Message2))
wherein the seq_increment is the sequence number increment, the Kbm is the binding management key, the Message2 is a message containing the previous sequence number or the previous sequence number increment, the HoA and the CoA of the MN, and/or the address of the CN, the PRF is a pseudo-random function, the First is a cut-off function, and the N is a natural number.

14. The method for binding update in the mobile IPv6 according to claim 13, wherein if the sequence number increment is 0, another sequence number increment is calculated according to an expression as follows:
seq_increment=First(N,Kbm XOR HoA)
wherein the HoA is the home address of the MN, and the XOR is an Exclusive-OR function.

15. A mobile IPv6 communication system, comprising a mobile node (MN), a correspondent node (CN), and a home agent (HA), wherein,
the MN is adapted to send a Care-of Test Init (CoTI) message to the CN, send a Home Test Init (HoTI) message to the HA, receive a Care-of Test (CoT) massage containing a care-of keygen token returned by the CN, receive a Home Test (HoT) message containing a home keygen token forwarded by the HA, generate a binding management key (Kbm) based on the home keygen token and the care-of keygen token, add an encrypted home address (HoA) option carrying an HoA encrypted with the Kbm in a BU message, and send the BU message from a substitute of home address (SHoA) which is used to replace the HoA;
the HA is adapted to forward the HoTI message to the CN, with carrying the SHoA in a destination option extension header containing an SHoA option of the HoTI message, receive the HoT message sent by the CN, search for the corresponding HoA of the MN according to the SHoA in a Type-2 routing header of the HoT message, and forward the HoT message to the MN in a tunnel mode; and
the CN is adapted to receive the HoTI message forwarded by the HA, replace the HoA with the SHoA to generate the home keygen token, return the HoT message containing the home keygen token to the HA, and carrying the SHoA in the Type-2 routing header of the HoT message, and bind the SHoA, the HoA, and a care-of address (CoA) according to the BU message.

16. A correspondent node (CN) in an IPv6 communication system, comprising:
a second return routability unit, adapted to perform a return routability procedure (RRP) comprising returning keygen tokens to a mobile node (MN) in the RRP;
a binding management key (Kbm) unit, adapted to calculate and generate the Kbm based on the keygen tokens; and
a second binding update (BU) unit, adapted to obtain a home address (HoA) of the MN encrypted with the Kbm from a BU message sent by the MN, and bind a substitute of home address (SHoA) of the MN, the HoA of the MN, and a care-of address (CoA) of the MN.

17. The CN in an IPv6 communication system according to claim 16, wherein the key tokens comprise a home keygen token and a care-of keygen token, the care-of keygen token is generated by the second return routability unit according to the CoA of the MN and is sent to the MN in a Care-of Test (CoT) message in the RRP, and the home keygen token is generated by the second return routability unit according to the SHoA of the MN and is sent to the MN in a Home Test (HoT) message in the RRP.

18. The CN in an IPv6 communication system according to claim 16, wherein the BU message further comprises an HoA index corresponding to the HoA of the MN; and
the second BU unit comprises an address index module adapted to bind a value of the HoA index, the SHoA, the HoA, and the CoA.

19. The CN in an IPv6 communication system according to 16, wherein the BU message further comprises a sequence number; and
the CN further comprises a second sequence number unit adapted to obtain a current sequence number by adding a previous sequence number and a current sequence number increment, and the current sequence number increment is calculated according to the Kbm and the previous sequence number or a previous sequence number increment.
